(19) United States
(12) Patent Application Publication
(10) Pub. No.: US 2024/0119852 A1
(43) Pub. Date: Apr. 11, 2024

(54) Singing campfire

(71) Applicant: Shawn Paul Kelly, Nashue, NH (US)

(72) Inventor: Shawn Paul Kelly, Nashue, NH (US)

(21) Appl. No.: 17/931,129

(22) Filed: Oct. 9, 2022

(51) Int. Cl. F21S 10/04; F21V 33/00

(52) U.S. Cl. CPC F21S 10/04; F21V 33/0056; F21W 2131/30

(57) ABSTRACT

This invention simulates a real campfire by way of shape and form. It is comprised of 2 panels that are easy to quickly assemble. It applies a feature of provisions to install lights into the unit with the ability to incorporate individually addressable programmable lighting that adds an array of features, to include sound reactive lighting, simulated dancing and singing. This unit can replace a traditional campfire and provide entertainment in the form of lighting sequences that simulate a natural campfire.

### BACKGROUND OF THE INVENTION

Designed elements Incorporated with custom programmable lighting creates illusions and entertainment. This device combines both to achieve a unique effect in the form of a campfire theme.

### (1) FIELD OF THE INVENTION

The present application relates to a device that is designed to resemble a natural campfire. The device has provisions to Install LED lights, around the eyes, nose and mouth to the create the face. Artificial logs create the appearance of legs when it. There are lighting provisions at the outer perimeter to create the silhouette of a campfire. Programmable lighting creates the illusion that the device is simulating speech, storytelling, dancing and singing by way of lighting sequences controlled by programmable software. The programming Incorporates sound, which works in harmony with the lighting sequences to create the illusion that the device is talking, singing, dancing and a variety of facial expressions.

### BRIEF SUMMARY OF THE INVENTION

2 modular panels assemble to form an artificial campfire that can be decorated with LED lights (as well as incandescent if so desired). There are 2 variations. One with a flat face and another with a split face. Installing programmable led lighting in the predrilled holes will light in pre-determined sequences to simulate singing, dancing, and storytelling.

### BRIEF DESCRIPTION OF THE SEVERAL VIEWS OF THE DRAWING(S)

FIG. 1 shows the front panel of the unit. Reference character number 1 represents one of the many holes in order to install lights throughout the unit. Reference character number 2 represents a notch out provided to assemble the 2 parts of the unit to form 1 complete unit.

FIG. 1A shows the second panel of the unit. Reference character number 1 represents one of the many holes in order to install lights throughout the unit. Reference character number 2 represents a notch out in order to assemble the 2 parts the unit to form 1 complete unit.

FIG. 1B shows both panels assembled to form one unit. Reference character 1 represents the unit in FIG. 1 assembled into FIG. 1A.

FIG. 2 is the flat faced version with no notch. Reference number 1 represents one of the many holes in order to install lights.

FIG. 2A represents a gusset to assist the panel to sit upright. Reference number 1 represents the gusset. Reference number 2 represents the front of the unit (see FIG. 2)

FIG. 3 shows the fat face unit with logs that also have the provisions for lights.

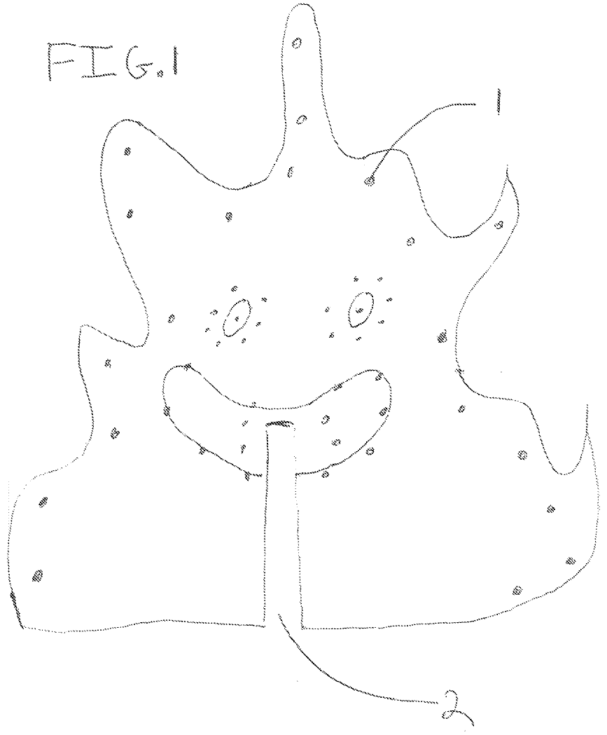

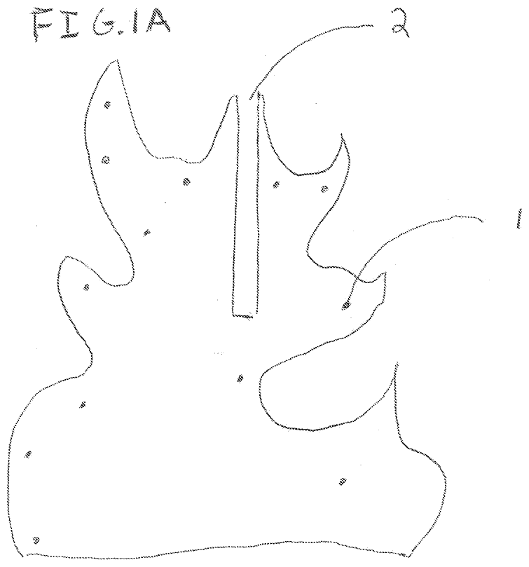

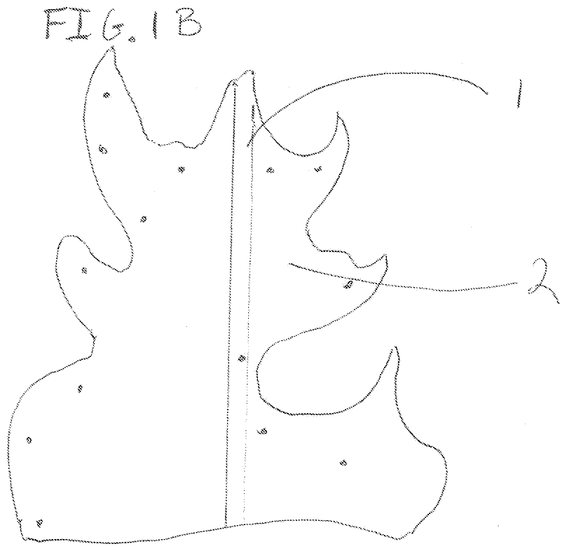

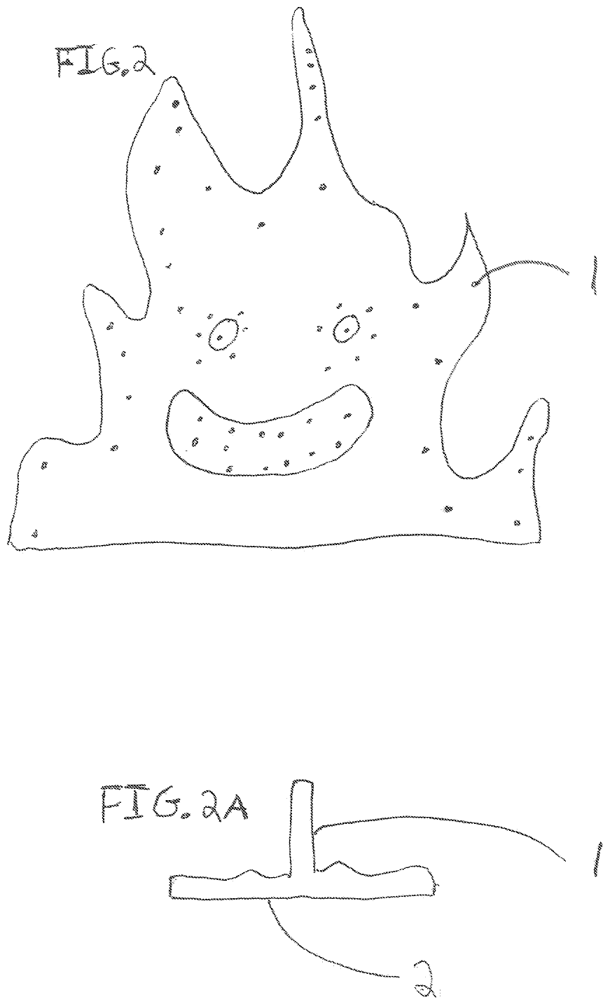

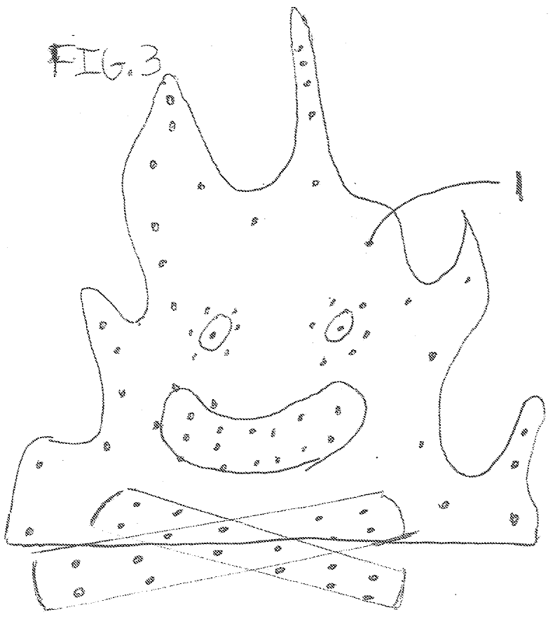

### DETAILED DESCRIPTION OF THE INVENTION

There are 2 versions of this device herein. The first is made up of 2 panels that are assembled by connecting the panels at the notches on the center of each split panel. The second is a flat face panel variation that is supported by a singular gusset attached to the rear of the panel. The second variation creates a at unobstructed front face. Both variations have simulated legs which appear to be logs in daylight, and illuminate in the dark to appear to be legs, by in way which the pre drilled holes are located and will be referred to as legs, due to the fact that the lighting effects create the visual illusion of legs when lights are sequenced accordingly and also create the appearance of the legs moving, running and dancing. The device accomplishes this by the numerous predrilled holes that house the lights. Light holes are pre drilled in locations that when fully installed simulate the shapes of eyes, nose, mouth, legs and located at the perimeter to cast an overall silhouette that appears to be a campfire.

1. The device looks like an artificial campfire in light. When in partial lighting or darkness, and lit up, the device can create the appearance of dancing, singing, talking blinking and general facial expression. This is accomplished with programmable lighting sequences
